(19) United States
(12) Patent Application Publication
(10) Pub. No.: US 2009/0049047 A1
(43) Pub. Date: Feb. 19, 2009

(54) STORING CUSTOM METADATA USING CUSTOM ACCESS CONTROL ENTRIES

(75) Inventors: Roopesh C. Battepati, Sammamish, WA (US); Michael C. Johnson, Bothell, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/839,287

(22) Filed: Aug. 15, 2007

(51) Int. Cl. G06F 17/30

(52) U.S. Cl. 707/9; 707/E17.106

(57) ABSTRACT

A computer-implemented system and method for storing custom metadata in a custom access control entry of a securable object. An exemplary method includes determining the custom metadata to be stored (e.g., information relating to the securable object that is inexpressible using a native file system application programming interface, information relating to remote domain permission data, information to support a custom feature of an application, etc.). The system may identify a custom access control entry (ACE) type corresponding to the custom metadata. In one embodiment, the custom ACE type is not a member of a set of ACE types directly interpretable by a native security subsystem to manage permissions for the securable object. The system may additionally store the custom ACE type and the custom metadata in a custom ACE, which may be added to the access control list of the securable object. The securable object may then be saved to the file system (e.g., to an NTFS file system).

### BACKGROUND

In file systems, securable objects, such as documents and folders, may be used to store data. Information about the stored data, which may be referred to as metadata, may be associated with the securable object. Metadata may be associated directly with a securable object as part of a securable object data structure (e.g., as part of a master file table or similar data structure), it may be associated indirectly with a securable object as part of an independent data structure (e.g., as a secondary file data stream, an extended attribute, etc.), or otherwise stored (e.g., within a database, within an XML document, etc.).

When a system developer wants to add a new type of metadata to a file, modifying the securable object data structure may be undesirable due to programming complexity, compatibility problems, or other considerations. Modifying an independent data structure or data store may overcome these limitations, but may introduce performance constraints, loss of functionality, loss of the metadata when the securable object is copied or moved, and may cause other problems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A computer-implemented system and method for storing custom metadata in a custom access control entry of a securable object. An exemplary method includes determining the custom metadata to be stored (e.g., information relating to the securable object that is inexpressible using a native file system application programming interface, information relating to remote domain permission data, information to support a custom feature of an application, etc.). The system may identify a custom access control entry (ACE) type corresponding to the custom metadata. In one embodiment, the custom ACE type is not a member of a set of ACE types directly interpretable by a native security subsystem to manage permissions for the securable object. The system may additionally store the custom ACE type and the custom metadata in a custom ACE, which may be added to the access control list of the securable object. The securable object may then be saved to the file system (e.g., to an NTFS file system).

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings.

FIG. 1 is logical diagram of an exemplary file management system having securable objects that include custom access control entries.

FIG. 2 is a logical diagram of an exemplary access control list having custom access control entries that store custom metadata.

FIG. 3 is a flow chart depicting a computer-implemented method for storing custom metadata in a custom access control entry.

FIG. 4 is a flow chart depicting a computer-implemented method for reading custom metadata from a custom access control entry.

FIG. 5 is a flow chart depicting an exemplary computer-implemented method for exporting a file having custom metadata stored in a custom access control entry.

FIG. 6 is a flow chart depicting an exemplary computer-implemented method for managing remote permissions with custom access control entry.

FIG. 7 shows a computer system in an exemplary implementation that is operable to enable storing custom metadata using custom access control entries.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

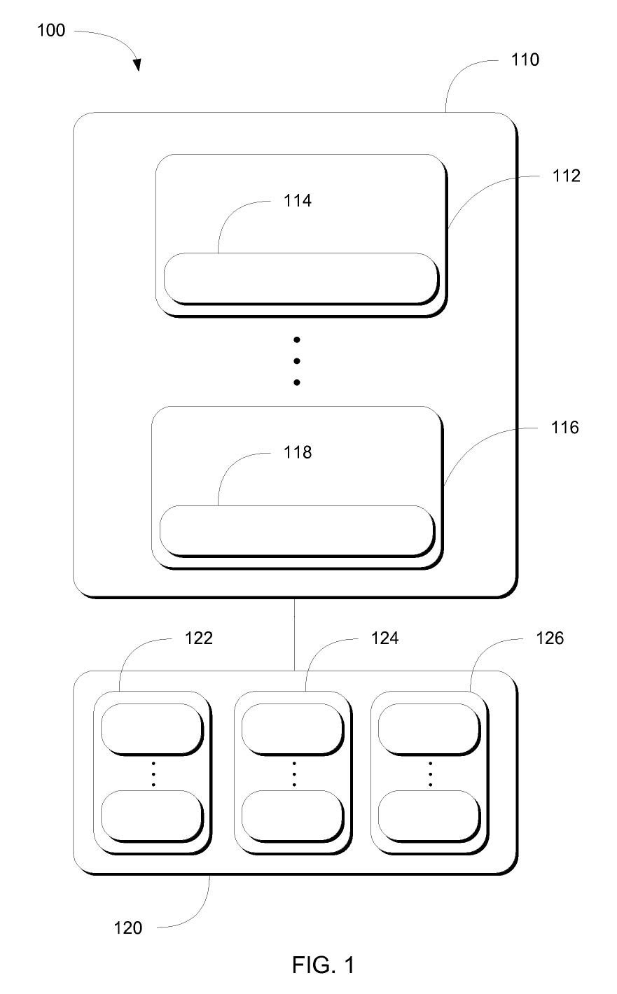

FIG. 1 is logical diagram of an exemplary file management system 100 having securable objects that include custom access control entries. Shown are a native file system 110 and a collection of native trustee accounts 120. For purposes of this application, the term native may be used to distinguish between a first set of related resources (systems, application programming interfaces (APIs), objects, etc.) that are related to one another and within which an activity of interest is presently occurring, and a second set of remote resources that is not within the native resources. In one embodiment, a native domain may be defined as a set of computers managed by a native security subsystem. In another embodiment, a native domain may be defined as a set of computers sharing a common API (e.g., a file system API) and/or a common collection of trustee accounts. An example of a native system may be a native domain including a number of computer systems having a WINDOWS brand of operating systems, such as a Windows domain. A remote system (e.g., a remote network, domain, computer, service, etc.), may be a resource that is not a member of the native system (e.g., not a member of the native domain).

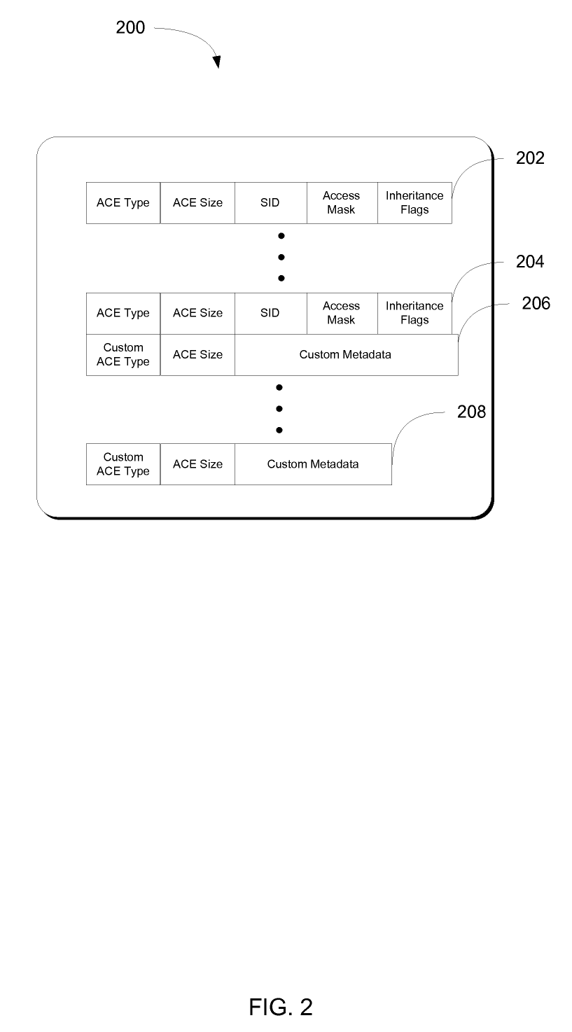

Turning to the objects depicted in FIG. 1, the native file system 110 manages (creates, modifies, reads, etc.) objects on a system's storage devices. Additionally, the native file system 110 may manage, in combination with the security subsystem, permissions that control access to objects within the native file system 110. The native file system 110 may include a number of securable objects 112, 116. The securable objects 112, 116 may include files, folders, and other types of named and unnamed objects. Each of the securable objects 112, 116 may have a security descriptor 114, 118. The security descriptors 114, 118 may store information about their associated securable object in accordance with the file system API. For example, the file system API may enable a securable object creator identifier, a securable object creation date, a securable object access control list (described in greater detail with respect to FIG. 2), and/or other information to be stored as part of the security descriptor 114, 118. An exemplary native file system 110 is a new technology file system (NTFS).

The native domain may include a collection of native trustee accounts 120. These trustee accounts 120 may include user accounts 122, group accounts 124, machine accounts 126, and/or other types of accounts. The trustee accounts 120 may be used to manage authentication and authorization within a native domain, including permissions within the native file system 110. In one embodiment, permissions stored in the native file system 110 correspond to objects within the collection of trustee accounts 120 (e.g., a conventional ACE for a securable object will have a SID corresponding to a SID of one of the trustee accounts). The trustee accounts may be part of and/or work in conjunction with the security subsystem. The security subsystem may be responsible for a variety of security operations, including, for example, enforcing access rules defined by the set of standard access control entries within a discretionary access control list. It may additionally be responsible for auditing attempts to access the securable object based on standard access control entries within a system access control list.

Turning to FIG. 2, depicted is a logical diagram of an exemplary access control list having custom access control entries that store metadata. Although not a limiting example, the access control list 200 of FIG. 2 may be implemented as part of a security descriptor 114, 118 depicted in FIG. 1 and described above. The access control list 200 may include a first data field containing data representing an ACE type. ACE types may include allow, deny, and audit, and these ACE types may be directly interpretable by a security subsystem. In one embodiment, directly interpretable by a security subsystem may mean that information (e.g., an ACE type, access mask, SID, inheritance information, etc.) may be used directly by the security subsystem to determine permissions to and/or auditing of a securable object based at least partially on the information. In one embodiment, an ACE may also include an ACE size field that may be used to identify the size (e.g., in bits) of an ACE.

The access control list 200 typically includes a plurality of conventional access control entries 202, 204, also referred to as conventional ACEs. Each conventional ACE 202, 204 may have a conventional ACE type (e.g., an ACE type that may be used by a native security subsystem in managing permissions within a native domain, including allow, deny, and audit ACE types). Each conventional ACE also may include a second data field configured to store a security identifier that corresponds to a trustee account within the domain. For example, the second data field may be configured to receive a security identifier (SID) corresponding to a trustee account (e.g., a user account, a group account, a machine account, etc) within the native domain. The conventional ACEs 202, 204 may also include a third data field containing data representing an access mask that, in combination with the first data field (e.g., ACE type) and the second data field (e.g., SID), determines a permission for a trustee for the securable object.

In addition to the conventional ACEs 202, 204, an access control list 200 may include custom ACEs 206, 208 having custom ACE types. Custom ACEs 206, 208 also have the first field of data (e.g., the ACE type), but the data within the custom ACE type field is not within the set of ACE types used by a security subsystem to manage permissions for a securable object. The custom ACE types may be determined by application developers, operating system developers, and/or other entities in order to support new functionality and/or provide additional information that may be inexpressible using a native file system API.

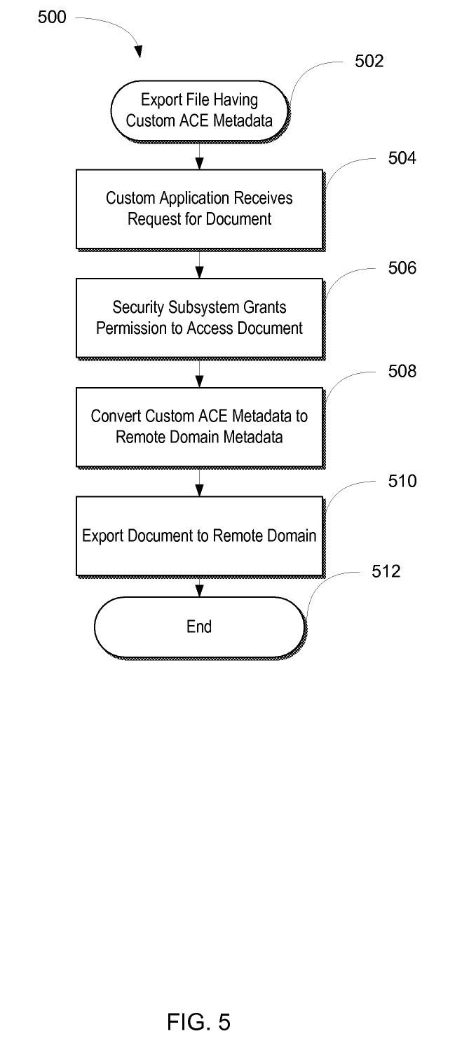

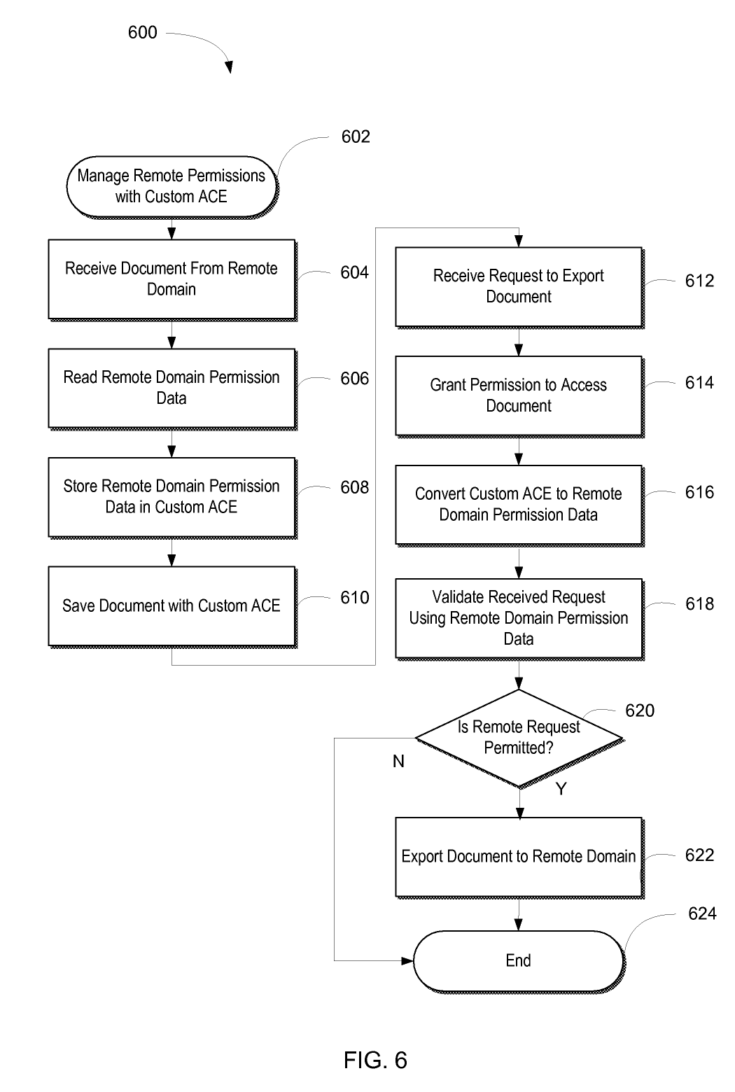

Exemplary functionality implemented by custom ACEs and referred to with custom ACE types may include remote domain metadata storage (e.g., “sticky bit” information in a file system that does not include “sticky bit” information within its API, storing remote domain permissions directly with a file as described with respect to FIG. 5, etc.), remote domain permission enforcement (e.g., as described below with respect to FIG. 6), enhanced native domain functionality (e.g., provide metadata that enables functionality not supported by the native file system API), and/or other functionality. The custom ACE type may be used to identify the type of custom metadata that is stored by the custom ACE.

In addition to the ACE type field having the custom ACE type data, custom ACEs may have a custom metadata field (e.g., a fourth data field). Custom metadata may be described as metadata that does not correspond to conventional ACE metadata. In one embodiment, the custom ACE type and custom metadata, individually or in combination, do not include information interpretable by a native security subsystem. In one example, custom metadata does not include a native SID, a native access mask, and/or native inheritance information. In another example, a custom ACE added to a discretionary access control list (DACL) and/or system access control list (SACL) of a securable object does not affect native permissions relating to the object. The native permissions may be unaffected because the custom ACE does not have a SID corresponding to the SID of any trustee account, the custom ACE type does not correspond to an ACE type that is managed by a security subsystem, and/or for other reasons.

The size of the custom ACEs may be uniform or different from each other and from conventional ACEs, depending on the purpose of and/or data in the custom ACE. The meaning of the data within a particular custom metadata field may be dependent upon the ACE type. Custom metadata may be stored as plain text, hashed, encrypted, a combination thereof, or using other techniques.

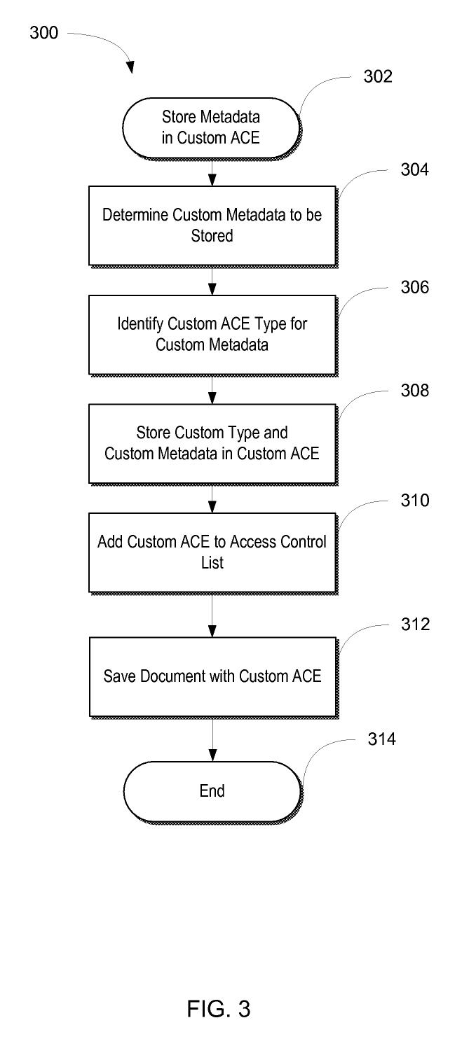

Turning to FIG. 3, shown is a flow chart depicting a computer-implemented method for storing metadata in a custom access control entry. This method involves a securable object having permissions managed by a security subsystem. Determining 304 the custom metadata to be stored may involve an application or an operating system identifying a collection of metadata to store in an access control list (e.g., the DACL and/or the SACL) of the securable object. In one embodiment, custom metadata may be metadata that is not expressible within the access control list using the API of the native file system.

Identifying 306 a custom ACE type corresponding to the custom metadata may involve identifying a custom ACE type that is not a member of a set of ACE types used by the security subsystem to manage permissions for the securable object (e.g., ACE types corresponding to set of non-extensible ACE types used by the native security subsystem such as access allowed, access denied, and system audit). For example, custom ACE types may include custom ACE types that identify metadata corresponding to remote domain metadata storage (in which the remote domain has an operating system different than the native operating system), remote domain permission enforcement, enhanced native domain functionality, and/or other functionality. The custom ACE types may be determined by an application developer either before or after a native operating system is released, whereas the set of ACE types used by the security subsystem may be determined by the native operating system developer prior to the release of the operating system.

Storing 308 the custom ACE type and the custom metadata in a custom ACE may involve invoking a method or procedure on a file system to create an ACE having the custom ACE type and custom metadata. The created custom ACE may not include information relating to a set of native security information, the set including a security identifier, an access mask, and a set of inheritance information. The system may then add 310 the custom ACE to the access control list of the securable object and save 312 the securable object with the custom ACE having the custom metadata to the file system.

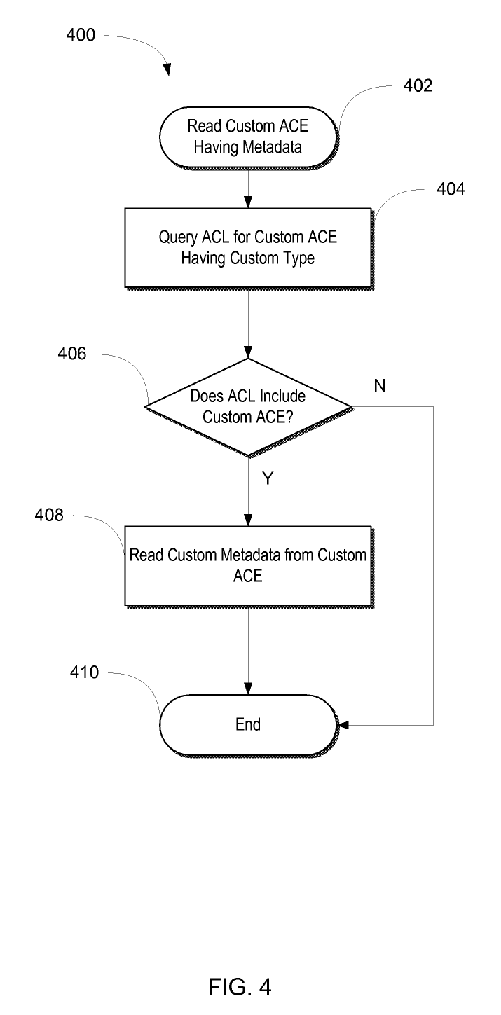

In addition to storing custom metadata in a custom ACE, custom metadata may also be read from a custom ACE stored as part of an ACL in a file system. One method of reading custom metadata from a custom ACE is depicted in FIG. 4. In this method, a file system may query 404 an ACL for a custom ACE having a custom ACE type. The file system may determine whether the ACL includes a custom ACE 406 having the custom ACE type. If a matching custom ACE is present (yes at 406), the method may proceed to reading 408 the custom metadata from the custom ACE. The computer-implemented method completes at 410 after reading 408 (and also if a matching ACE is not present, no at 406).

A variety of techniques may be used to actually implement the method of FIG. 4, including performing the method by the operating system, file system, or other driver, system, subsystem, etc., operating in kernel mode (e.g., having direct access to the ACL). Additionally or alternatively, the method may be implemented using a driver, application, etc., operating in user mode that makes a request for the ACL via a kernel mode system (e.g., the file system).

FIG. 5 is a flow chart depicting an exemplary computer-implemented method for exporting a file having custom metadata stored in a custom access control entry. For purpose of explanation, the custom metadata corresponds to permission data for a remote domain. Exemplary permission data for a remote domain may include remote domain permission data that is not expressible using an available file system API, such as permission data stored by a different type of operating system including, but not limited to, a Set User ID (SUID) and/or a Set Group ID (SGID). Other types of custom metadata may be stored and exported, such as “sticky bit” information for applications (e.g., to specify that files within a directory that has the sticky bit set can be renamed or deleted only by the owner of the file, owner of the directory or the superuser account and/or to specify whether an application is to be retained in memory after execution), a date on which a file was imported into a native file system (as opposed to a date the file was created on a remote file system), or other information that may be desirable to store directly with a securable object.

Regarding the particular elements depicted in FIG. 5, receiving 504 a request to export the document may include receiving a request for the document and an identifier of a requester (user, group, and/or, machine account, etc.). This request may be received by a custom application, for example. The requester identifier may be part of message (e.g., as content delivered in a payload of a message received from a remote domain), as part of a session identifier, provided or determined by the custom application, or otherwise transmitted from the remote domain. Upon receiving 504 the request, the native file system may grant 506 permission to access the document. It is understood that this element does not grant access to export the document from the native domain, but instead grants access to the custom application to inspect the requested document (e.g., to evaluate the ACL of the document). The granting 614 element may be adjusted to suit a particular operating environment (e.g., it may be eliminated or modified if the export functionality is performed by a driver, system, or subsystem operating in kernel mode).

The custom ACE may be converted 508 to the remote domain permission data. This conversion may involve reading the custom ACE as described above with respect to FIG. 4 and converting the custom ACE of the metadata into a remote domain permission scheme format (e.g., a format including a remote User Identifier or UID, a remote Group Identifier or GID, and remote permission bits). The system may export 510 the document to the remote domain.

FIG. 6 is a flow chart depicting an exemplary computer-implemented method for managing remote permissions with a custom access control entry. Specifically, FIG. 6 depicts a computer-implemented method for managing permissions by a native domain on behalf of a remote domain using a custom ACE. The method includes receiving 604 a document (e.g., a text document, an image or video file, or other securable object) from the remote domain, the document including a set of permission data that is presented in a remote domain permission schema different than a native domain permission scheme. These permissions may be directly associated with the document (e.g., as part of the document, in a security descriptor associated with the document, etc.), as part of a communication that includes the document (e.g., as part of a message from a remote domain, a session identifier, etc.), or otherwise communicated from the remote domain to the native domain.

Reading 606 the remote domain permission data may involve accessing the remote permission data received at 604. This permission data may have, for example, a format including a remote owner unique identifier (UID), a remote group identifier (GID), and user permission bits, group permission bits, and other permission bits. Additionally or alternatively, remote permission data may include “sticky bit” information for folders (e.g., to identify whether a user other than an owner of an included document may delete the document) or other information.

Storing 608 the remote domain permission data in a custom ACE may, for example, implement the elements described with respect to FIG. 3 above, including saving 610 the document with custom ACE.

A subsequent communication from a remote domain may initiate an export process. Although the export algorithm described above with respect to FIG. 5 may be used, it is understood that the present export algorithm is different than the above described algorithm. Specifically, the export algorithm (elements 612-622) are not only storing remote permission data, but also evaluating whether a received request is permitted based on security information received from the remote domain at 612.

Turning to the particular elements, receiving 612 a request to export the document may include receiving a request for the document and an identifier of a requestor (user, group, and/or, machine account, etc.). The requestor identifier may be part of message (e.g., as content delivered in a payload of a message received from a remote domain), as part of a session identifier, or otherwise transmitted from the remote domain. Upon receiving 612 the request, the native file system may grant 614 permission to access the document. It is understood that this element does not grant access to export the document from the native domain, but instead grants access to inspect the requested document (e.g., to evaluate the ACL of the document). The granting 614 element may be adjusted to suit a particular operating environment (e.g., it may be eliminated or modified if the export functionality is performed by a driver, system, or subsystem operating in kernel mode).

The custom ACE may be converted 616 to the remote domain permission data. This conversion may involve reading the custom ACE as described above with respect to FIG. 4 and converting the custom ACE of the metadata into a remote domain permission scheme format (e.g., a format including a remote UID, a remote GID, and remote permission bits). The received request may be validated 618 using the remote domain permission data in combination with the received requestor identifier. If the remote request is permitted (yes at 620), the system may export 622 the document to the remote domain. When the received request is not permitted (no at 620), the system may proceed to 624 and deny the request to export the document to the remote domain.

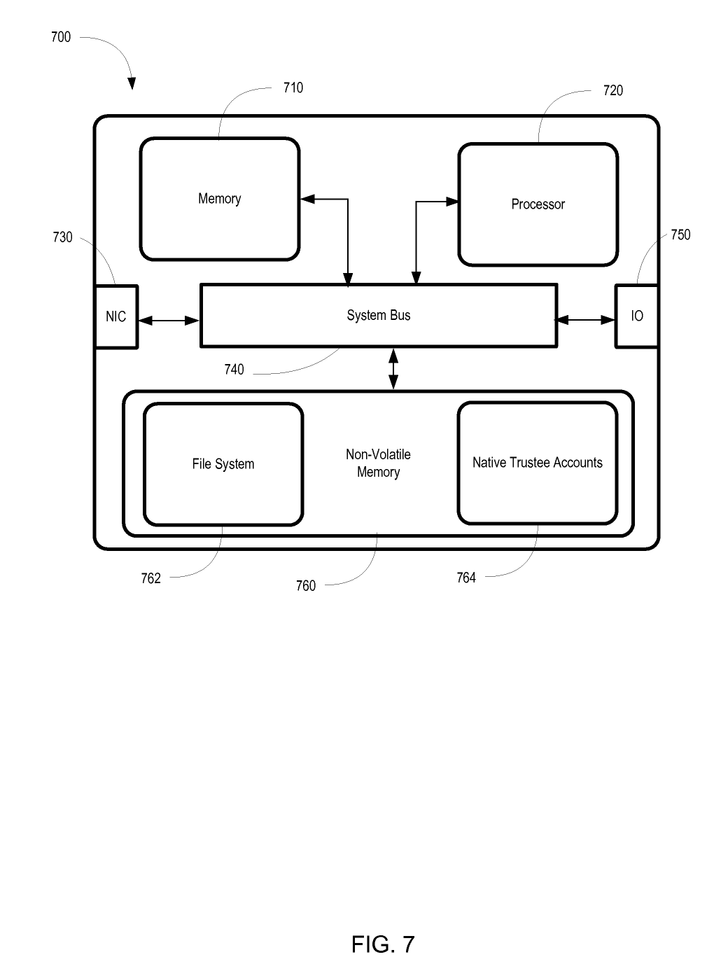

FIG. 7 shows a computer system 700 in an exemplary implementation that is operable to store and read custom metadata using custom access control entries. It is understood that the depiction of the components of the computer system 700 within a single computing system is for exemplary, non-limiting purposes only, and that the computer system 700 may be implemented using several computers and/or servers interconnected by wired and/or wireless networks.

The computer system may include a memory device 710, such as random access memory, a processor 720, such as a microprocessor, a network interface 330, such as a network interface card, an Input/Output communication port 750, such as a USB port, and a system bus 740 that interconnects the components of the computer system 700. The network interface may enable communication with a remote computer system (not shown). Additionally, the computer system 700 may include non-volatile memory 760 having computer readable data including a file system 762 having an access control list with custom access control entries. The non-volatile memory 760 may also include native trustee accounts 764. During program execution, data and instructions may be transferred between the non-volatile memory 760 to memory 710.

Volatile memory 760 and memory 710 are both examples of computer readable storage media. By way of example, and not limitation, computer readable storage media may include volatile and non-volatile, removable and non-removable media implemented in any method or technology for storage of information such as computer readable instructions, data structures, program modules, or other data. Computer readable storage media includes, but is not limited to, RAM, ROM, EEPROM, flash memory, or other memory technology, CD-ROM, digital versatile disks (DVD) or other optical storage devices, or any other medium which can be used to store the desired information and which can be accessed by computer system 700.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like. Furthermore, although the context for the disclosed system and method are for custom metadata stored in and read from custom access control entries, the system and method may operate outside the custom access control entry context, such as application programming interfaces for file systems other than or in addition to NTFS (e.g., file systems for other types of operating systems).

1. A computer-implemented method for storing custom metadata in an access control list of a securable object having permissions managed by a native security subsystem, the method comprising:
determining the custom metadata to be stored;
identifying a custom access control entry (ACE) type corresponding to the custom metadata, wherein the custom ACE type is not a member of a set of ACE types directly interpretable by the native security subsystem to manage permissions for the securable object;
storing the custom ACE type and the custom metadata in a custom ACE;
adding the custom ACE to the access control list of the securable object; and
saving the securable object with the custom ACE having the custom metadata to a file system.

2. The method of claim 1, wherein the custom ACE includes no information relating to a set of native security information directly interpretable by the native security subsystem, the set comprising:
a security identifier;
an access mask; and
a set of inheritance information.

3. The method of claim 1, wherein the set of ACE types directly interpretable by the native security subsystem by the native security subsystem relate to access denied, access allowed, and system audit.

4. The method of claim 1, wherein the set of ACE types used by the native security subsystem is a non-extensible set for a native operating system.

5. The method of claim 4, wherein the custom ACE type is determined by an application developer and the set of ACE types directly interpretable by the native security subsystem is determined by the native operating system developer.

6. The method of claim 1, wherein the custom metadata comprises access control information relating to the securable object that is usable by a remote operating system that is different than a native operating system.

7. The method of claim 1, wherein the custom metadata comprises information about the securable object that is not expressible using an application programming interface of the file system.

8. The method of claim 7, wherein the file system comprises a new technology file system (NTFS).

9. The method of claim 7, wherein the custom metadata comprises at least one of a set of remote permission metadata, the set comprising a sticky bit indicator, a user identifier, a group identifier, a set user identifier, and a set group identifier.

10. The method of claim 1, wherein the custom ACE is a member a discretionary access control list.

11. The method of claim 10, wherein the custom ACE does not include data corresponding to a native trustee account that is directly interpretable by the native security subsystem.

12. The method of claim 10, wherein the custom ACE does not include data corresponding to an access mask that is directly interpretable by the native security subsystem.

13. The method of claim 1, wherein the native security subsystem manages permissions for the securable object by:
enforcing access rules defined by a set of standard access control entries within a discretionary access control list; and
auditing attempts to access the securable object based on standard access control entries within the system access control list.

14. The method of claim 13, wherein adding custom access control entries does not affect permissions to or auditing of the securable object within the native security subsystem.

15. A computer-readable medium having stored thereon an access control list data structure for a securable object managed by a file system within a domain, the data structure comprising:
a first data field containing data representing an ACE type, wherein the data structure includes:
at least one conventional ACE having a conventional ACE type; and
at least one custom ACE having a custom ACE type;
for the conventional ACE:
a second data field configured to store a security identifier that corresponds to a trustee account within the domain;
a third data field containing data representing an access mask that, in combination with the first data field and the second data field, determines a permission for a trustee for the securable object; and
for the custom ACE, a fourth data field containing custom metadata.

16. The computer-readable medium of claim 15, wherein the fourth data field is different than each of:
the second data field;
the third data field; and
a combination of the second and third data field.

17. The computer-readable medium of claim 15, wherein the access control list comprises a discretionary access control list.

18. A computer-implemented method for managing permissions by a native domain on behalf of a remote domain using a custom ACE, the method comprising:
receiving a document from the remote domain, the document including a set of permission data that is presented in a remote domain permission schema different than a native domain permission scheme;
reading the remote domain permission data;
storing the remote domain permission data in a custom ACE; and
saving the document with custom ACE.

19. The computer-implemented method of claim 18, further comprising:
receiving a request to export the document;
granting permission to access the document;
converting the custom ACE to the remote domain permission data;
validating the received request using remote domain permission data;
when the received request is permitted, exporting the document to the remote domain; and
when the received request is not permitted, denying the request to export the document to the remote domain.

20. The computer-implemented method of claim 18, wherein the custom ACE is added to a discretionary access control list.
